(19) United States
(12) Patent Application Publication
(10) Pub. No.: US 2011/0274560 A1
(43) Pub. Date: Nov. 10, 2011

(54) Pump Assemblies, Controllers and Methods of Controlling Fluid Pumps Based on Air Temperature

(75) Inventors: Bret S. Clark, St. Louis, MO (US); Donald E. Morgan, Florissant, MO (US); Mary P. Shadrach, O'Fallon, MO (US)

(73) Assignee: Emerson Electric Co., St. Louis, MO (US)

(21) Appl. No.: 12/774,430

(22) Filed: May 5, 2010

(51) Int. Cl. F04B 49/00; G05D 7/00

(52) U.S. Cl. 417/14; 417/53; 700/282

(57) ABSTRACT

Pump assemblies, controllers and methods of controlling fluid pumps based on air temperatures are disclosed. One example method of controlling a fluid pump includes determining an air temperature, determining a run time of the fluid pump based on the determined air temperature, and running the fluid pump for a duration corresponding to the determined run time. One example controller for a fluid pump includes a temperature sensor for measuring an air temperature and a processor for controlling a run time of the fluid pump. The processor is operably coupled to the temperature sensor and configured to adjust the run time of the fluid pump based on a predetermined run time and the air temperature measured by the temperature sensor. The pump assemblies, controllers and methods may be used in swimming pools and various other applications.

### FIELD

The present disclosure relates to pump assemblies, controllers and methods of controlling fluid pumps based on air temperature.

### BACKGROUND

This section provides background information related to the present disclosure which is not necessarily prior art.

Fluid pumps are commonly used for displacing and/or circulating fluids in various applications. For example, swimming pools are usually provided with a fluid pump (also called a pool pump) to circulate water through one or more filters to clean and disperse chemicals into the water. Some fluid pumps (including pool pumps) are operated according to a timer that can be manually adjusted by a user. For example, timers are often used to operate pool pumps at one or more speeds for a preset number of hours each day. However, the amount of time a pool pump must operate to keep a pool clean may vary during the pool season. Accordingly, some pool pump controllers automatically adjust the run time of the pool pump over the course of the pool season, with the pump operated for longer periods during the typically warmer months (e.g., July and August) than during the typically cooler months (e.g., June and September). Similarly, other pool pump controllers automatically adjust the run time of the pool pump based on a measured temperature of the pool water. These controllers may be more effective at optimizing the run time of the pump to maintain clean water conditions at a minimum energy cost, but are generally more complex and costly than the calendar-based pump controllers that do not measure the water temperature.

### SUMMARY

This section provides a general summary of the disclosure, and is not a comprehensive disclosure of its full scope or all of its features.

According to one aspect of the present disclosure, a controller for a fluid pump includes a processor for controlling a run time of the fluid pump. The processor is configured to adjust the run time of the fluid pump based on a predetermined run time and a determined air temperature.

According to another aspect of the present disclosure, a pump assembly includes a pump motor, a fluid pump operatively coupled to the pump motor for displacing fluid, and a controller for the pump motor. The controller is configured to control a run time of the pump motor based on a measured air temperature.

According to yet another aspect of the present disclosure, a method of controlling a fluid pump is disclosed. The method includes determining an air temperature, determining a run time of the fluid pump based on the determined air temperature, and running the fluid pump for a duration corresponding to the determined run time.

Further areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a method of controlling a fluid pump according to one example embodiment of the present disclosure.

FIG. 2 is a block diagram of a controller for a fluid pump according to another example embodiment of the present disclosure.

FIG. 3 is a block diagram of a fluid pump assembly including the controller of FIG. 2 according to another example embodiment of the present disclosure.

FIG. 4 is a block diagram of a fluid pump controller according to yet another example embodiment of the present disclosure.

FIG. 5 is a block diagram of a fluid pump assembly including the controller of FIG. 4 according to still another example embodiment of the present disclosure.

FIG. 6 is a graph depicting temperature variations over the course of a day in March, June, September and December.

FIG. 7 is a perspective view of one example implementation of the fluid pump assembly of FIG. 5.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on” “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

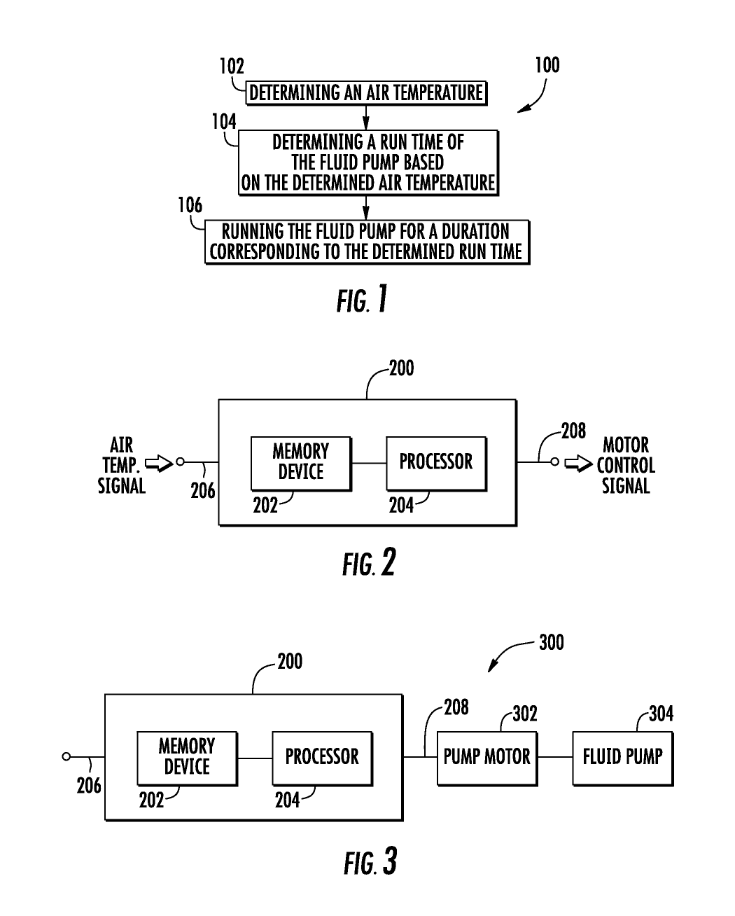

FIG. 1 illustrates a method of controlling a fluid pump according to one example embodiment of the present disclosure. As shown in FIG. 1, the method 100 includes determining an air temperature (102), determining a run time of the fluid pump based on the determined air temperature (104), and running the fluid pump for a duration corresponding to the determined run time (106). In this manner, the run time of the fluid pump can be automatically controlled in response to the determined air temperature. As further explained below, the determined air temperature may be a single measured air temperature, an average air temperature, a normalized air temperature, an average normalized air temperature, or any other suitable air temperature value.

When applied to pools (e.g., swimming pools, spa pools, hot tubs, etc.), the method of FIG. 1 can be used, e.g., to automatically optimize a run time of the pool pump based on the ambient air temperature, which is indicative of the water temperature, without requiring expensive or complex sensor arrangements for measuring the water temperature. It should be understood, however, that the method 100 is not limited to pool pumps and can be applied to a variety of other fluid pump applications.

The air temperature can be determined in any suitable manner. For example, the air temperature can be determined by measuring the air temperature with a temperature sensor. However, if the temperature sensor is in close proximity to a pump motor, the pump motor may generate heat while operating that could affect the air temperature value measured by the temperature sensor. To address this issue, the air temperature value can be measured when the pump motor has been off for some period of time, such as two hours, so the air temperature can be measured accurately after the pump motor has cooled. Alternatively, the temperature sensor may be thermally isolated from the pump motor so the air temperature value can be measured accurately, even while the pump motor is operating, without influence from heat generated by the pump motor.

As another alternative, the air temperature can be determined by receiving an air temperature signal from an external device or system. For example, an air temperature signal can be received, via wired or wireless means, from a nearby device having an air temperature sensor, a weather radio transmitter, an Internet website, etc.

As noted above, the determined air temperature may be based on a single air temperature value or multiple air temperature values. For example, multiple air temperatures can be determined over time (e.g., during a single day or over multiple days or weeks) and averaged to determine an average air temperature. The average air temperature (which may be, e.g., a weighted average, such as an exponentially weighted average, etc.) can then be used to determine the run time of the fluid pump.

Additionally, one or more air temperature values can be normalized based on when the air temperatures were measured. For example, it may be desirable to periodically measure air temperatures at the same time(s) each day. However, circumstances may prevent the air temperature from being measured at the desired time. For example, if the desired time for measuring an air temperature is 3 pm, but the pump motor was operating at 3 pm, measuring the air temperature might be delayed until 6 pm (e.g., after the pump motor has been off awhile and is no longer radiating heat). In that event, the air temperature measured at 6 pm can be normalized to approximate the air temperature at 3 pm (e.g., using historical temperature data or other techniques). The normalized air temperature (i.e., representing the air temperature at 3 pm) can then be used to determine the run time of the fluid pump.

Similarly, in the case where multiple air temperatures are measured or received over time for averaging purposes, one or more of the air temperatures can be normalized based on when they were acquired, and then averaged to determine an average normalized air temperature. The average normalized air temperature (e.g., representing the average temperature at a particular time of day for several consecutive days) can then be used to determine the run time of the fluid pump.

Various techniques can be employed for determining the run time of the fluid pump based on the determined air temperature. For example, the run time of the fluid pump can be automatically increased in response to warmer (or cooler) air temperatures, and/or automatically decreased in response to cooler (or warmer) temperatures. In some embodiments, a different run time is stored for each anticipated air temperature (or range of temperatures). In this manner, a fluid pump controller can retrieve from memory the particular run time corresponding to the determined air temperature, and run the fluid pump for a duration corresponding to that particular run time. In other embodiments, the determined air temperature is used to increase and/or decrease a predetermined run time (e.g., using a defined algorithm, stored multipliers, etc.). As a result, the determined run time of the fluid pump may be, e.g., greater than the predetermined run time during warm weather conditions and/or less than the predetermined run time during cool weather conditions. In these various embodiments, the predetermined run time(s), algorithm(s), multipliers, etc. may be selected or programmed into the fluid pump assembly at the factory, by the installer, by the end user, or otherwise. Alternatively, other suitable techniques can be employed to determine the run time of the fluid pump based on the determined air temperature without departing from the scope of this disclosure.

The method of FIG. 1 can be used to determine a single run time or multiple run times of the fluid pump based on the determined air temperature. For example, pool pumps are frequently run at a high speed for one period of time, and a low speed (which consumes less electricity) for another period of time, each day. For these and other applications, the method 100 of FIG. 1 can be used to determine two different run times of the fluid pump (e.g., a high speed or flow rate run time and a low speed or flow rate run time) based on the determined air temperature (and possibly one or more predetermined run times). Similarly, the method of FIG. 1 can be used to determine more than two run times for a fluid pump based on one or more determined air temperatures as may be desired in any given application of these teachings.

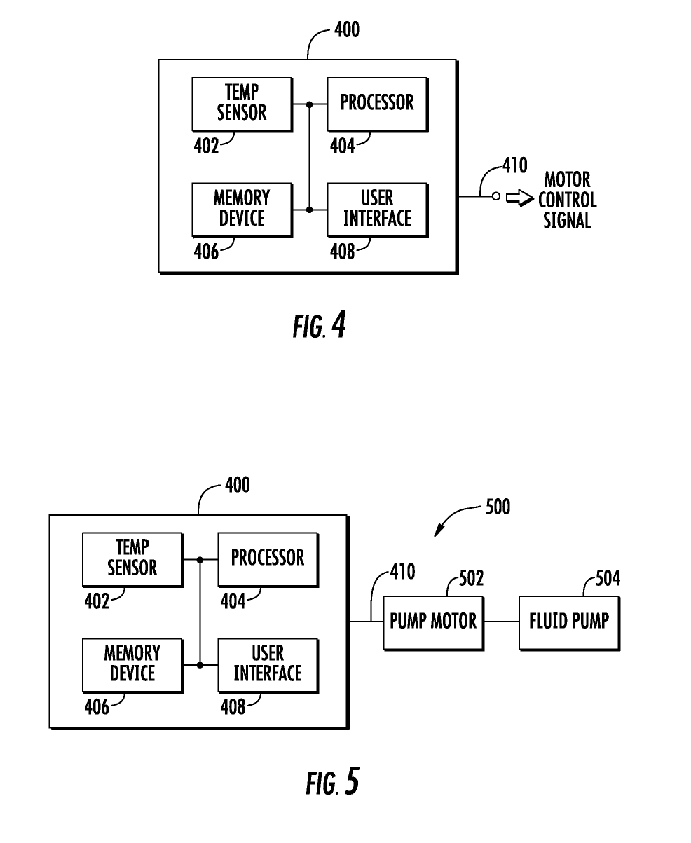

Some examples of fluid pump controllers and assemblies suitable for implementing the method 100 of FIG. 1 will now be described with reference to FIGS. 2-7. It should be understood, however, that the method of FIG. 1 is not limited to the particular controllers and assemblies described below, and can be implemented with other controllers or assemblies without departing from the scope of this disclosure. Similarly, the controllers and assemblies described below may be usable with other methods.

FIG. 2 illustrates a fluid pump controller 200 according to one example embodiment of the present disclosure. As shown in FIG. 2, the controller 200 includes a memory device 202 and a processor 204. Additionally, the controller 200 includes an input 206 for receiving an air temperature signal, and an output 208 for providing a pump motor control signal. The processor 204 is configured to determine a run time of the pump motor using the air temperature signal(s) received via the input 206, and to provide corresponding control signal(s) to the pump motor via the output 208.

The air temperature signal(s) received at the input 206 can be provided by any suitable source including, e.g., a nearby device having an air temperature sensor, a weather radio transmitter, an Internet website, etc.

FIG. 3 illustrates a fluid pump assembly 300 according to another example embodiment of the present disclosure. As shown in FIG. 3, the assembly 300 includes the controller 200 of FIG. 2, a pump motor 302 and a fluid pump 304. The pump motor 302 receives pump motor control signals from the controller 200 via the output 208, and is coupled to the fluid pump 304 for driving the pump 304 in response to the motor control signals.

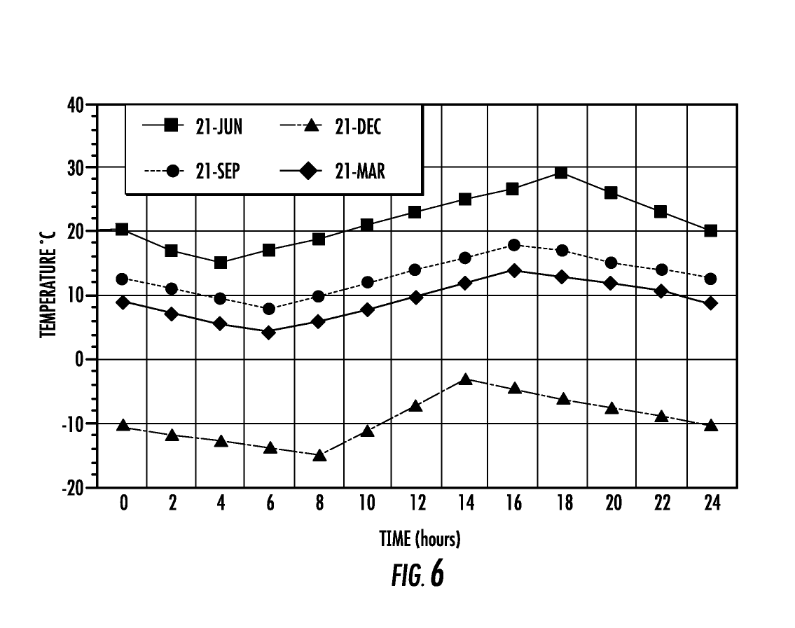

FIG. 4 illustrates a fluid pump controller 400 according to another example embodiment of the present disclosure. The controller 400 includes a temperature sensor 402 for measuring an air temperature and a processor 404 for controlling a run time of the fluid pump. As shown in FIG. 4, the controller 400 also includes a memory device 406, a user interface 408 for receiving data and/or commands from a user (including one or more run times for the fluid pump), and an output 410 for providing control signals to a pump motor. The processor 404 is operably coupled to the temperature sensor 402 and configured to adjust the run time of the fluid pump based on a predetermined run time and the air temperature(s) measured by the temperature sensor 402. The predetermined run time may be stored in the memory device 406 (or elsewhere) at the factory, by the installer, by the end user, etc.

FIG. 5 illustrates a fluid pump assembly 500 according to another example embodiment of the present disclosure. As shown in FIG. 5, the assembly 500 includes the controller 400 of FIG. 4, a pump motor 502 and a fluid pump 504. The pump motor 502 receives pump motor control signals from the controller 400 via the output 410, and is coupled to the fluid pump 504 for driving the pump 504 in response to the motor control signals.

If desired, the temperature sensor 402 can be thermally isolated from the pump motor 502. For example, if the controller 400 is mounted to the pump motor 502, the controller 400 and/or the pump motor 502 may include insulative material that permits the sensor 402 to accurately measure air temperatures, even while the pump motor 502 is operating, without influence from heat generated by the pump motor 502. Alternatively, the controller 400 can be physically spaced from the pump motor 502 (and connected to the pump motor 502 via wired or wireless means) a sufficient distance to permit the sensor 402 to accurately measure air temperatures, even while the pump motor 502 is operating, without influence from heat generated by the pump motor 502. As another alternative, the temperature sensor 402 can be physically spaced from the pump motor 502, with other component(s) of the controller 400 mounted to the pump motor 502 (or elsewhere), to permit the sensor 402 to accurately measure air temperatures without influence from heat generated by the pump motor 502.

In another example embodiment, the fluid pump assembly 500 of FIG. 5 is configured for use with pools (e.g., swimming pools, spa pools, hot tubs, etc.). In particular, the controller 400 is configured to receive from a user one or more run times for the fluid pump 504 (also called a pool pump in this example) via the user interface 408. For example, the user may input a high speed (or flow rate) run time, such as twelve hours, and a low speed (or flow rate) run time, such as four hours. Further, the controller 400 is configured to determine an air temperature (e.g., an average air temperature) via the temperature sensor 402.

In this particular example, the temperature sensor 402 is not thermally isolated from the pump motor 502. Instead, the controller is configured to collect temperature readings using the temperature sensor 402 only after the pump motor 502 has been off for a defined time, such as two hours. This ensures the temperature readings (which may be stored in the memory device 406 or elsewhere) are collected only after the pump motor 502 has cooled and will not be influenced by heat generated when the pump motor 502 was operating.

Preferably, one or more temperature readings are collected at the same time(s) each day. For example, the controller could be configured to measure the air temperature at midnight each day. However, if the pump motor 502 is operating at midnight on a particular day, the air temperature may not be measured until 2:00 AM. In that event, the air temperature measured at 2:00 AM can be normalized to estimate what the air temperature was at midnight.

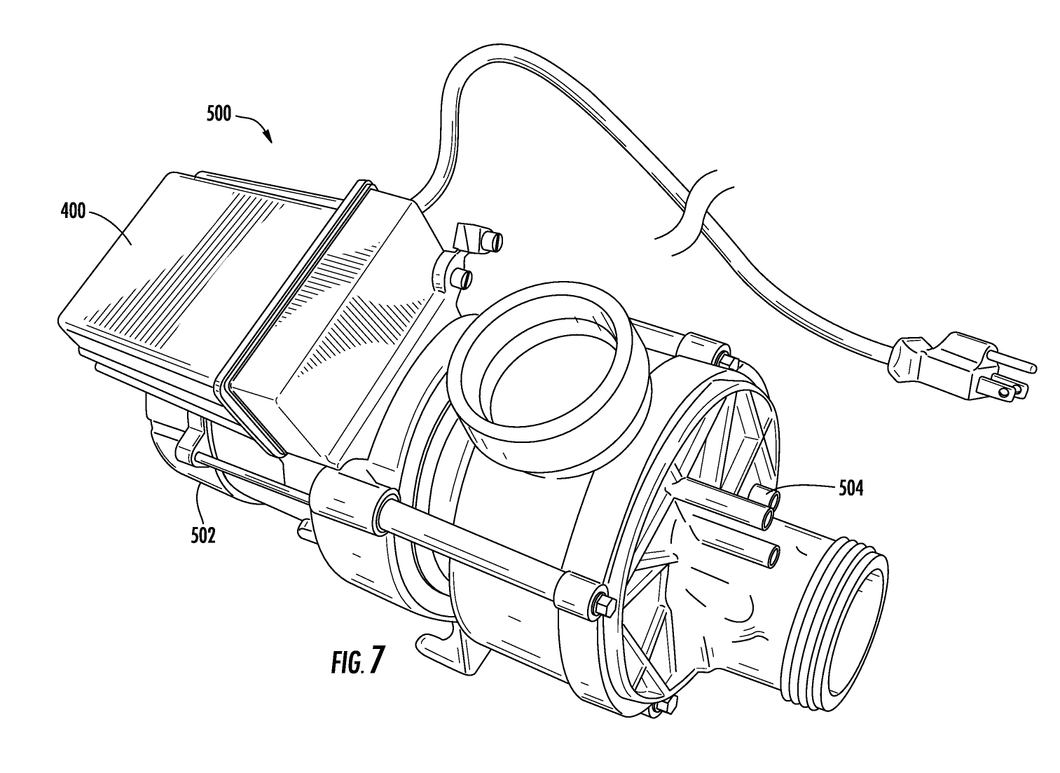

FIG. 6 illustrates the typical temperature variation which occurs over the course of one day (while the temperature chart of FIG. 6 is for a particular geographic location—forty-five degree North latitude—it should be understood that similar data can be used for other geographic locations). As shown in FIG. 6, the daily temperature variation for this geographic region is about plus or minus five degrees Centigrade. Using this data, the air temperature measured at one time of day can be used to estimate what the air temperature was (or will be) at another time of day. For example, Table 1 lists several adjustment factors (in degrees Celsius) that can be used to normalize a measured air temperature (where hour zero corresponds to midnight and hour twelve corresponds to noon).

TABLE 2

| Hour | Adjustment Factors |
|---|---|
| 0 | 0 |
| 2 | 2 |
| 4 | 4 |
| 6 | 5 |
| 8 | 3 |
| 10 | 1 |
| 12 | −1 |
| 14 | −3 |
| 16 | −5 |
| 18 | −4 |
| 20 | −2 |
| 22 | −1 |
| 24 | 0 |

As shown in Table 1, the adjustment factor for a temperature measurement at 2:00 AM (i.e., hour two) is 2° C. Thus, an air temperature of 30° C. measured at 2:00 AM can be normalized by adding the adjustment factor of 2° C. to produce an estimated air temperature at midnight of 32° C. This normalized air temperature of 32° C. can then be used (by itself or in combination with other measured and/or normalized air temperatures, etc.) to adjust the run time(s) of the pump motor 502, as further described below.

In this particular example, the run times input by the user determine the run times of the pump motor 302 on the warmest days of the season. Thus, the controller 400 is configured to automatically reduce the user-supplied run times in response to cooler air temperatures. Alternatively, the user could input run time(s) for the coolest days of the season, with the controller configured to automatically increase the run time(s) in response to warmer air temperatures. As yet another alternative, the user could input run time(s) for a particular time of year, air temperature, etc., with the controller configured to automatically increase or decrease the run time(s) in response to the determined air temperature.

Table 2 provides example adjustment multipliers for reducing the user-supplied run times in response to the determined air temperature.

TABLE 1

| Air Temperature (° C.) | Adjustment Multiplier |
|---|---|
| 5 | 0.5 |
| 7 | 0.55 |
| 9 | 0.59 |
| 11 | 0.64 |
| 13 | 0.68 |
| 15 | 0.73 |
| 17 | 0.77 |
| 19 | 0.82 |
| 21 | 0.86 |
| 23 | 0.91 |
| 25 | 0.95 |
| 27 | 1 |

In this particular example, for any temperature above 27° C. (roughly 80° F.), the adjustment multiplier is one (i.e., unity) such that the user-supplied run times are not reduced. For determined air temperatures below 27° C. but greater than 5° C., the user-supplied run times will be reduced according to the applicable adjustment multiplier. For example, if the determined air temperature is 15° C., the user supplied run time(s) are multiplied by 0.73, thereby reducing the user-supplied run times by twenty-seven percent. For determined air temperatures of 5° C. and below, the user-supplied run time(s) are multiplied by 0.5, resulting in a fifty percent reduction.

In this example, Table 2 is stored as a look-up table in the memory 406, and used by the processor 404 as necessary to adjust the user-supplied run time(s) in response to the determined air temperature. It should be understood, however, that other look-up tables, algorithms and approaches can be used to determine run time(s) for the pump motor 502 based on user-supplied run time(s) and the determined air temperature.

If the pump motor is a discrete speed motor, such as a single-speed, two-speed or three-speed motor, the user may input run time(s) for each operating speed, such as a high speed run time and a low speed run time. If the pump motor is a variable speed motor, the user may input the speed(s) at which the pump motor should operate, in addition to the corresponding run time(s) for each speed.

FIG. 7 is a perspective view of one example implementation of the fluid pump assembly 500 of FIG. 5. As shown in FIG. 7, the pump motor 502 is mounted to the fluid pump 504 for driving the fluid pump 504 when the pump motor 502 is on. Further, the controller 400—including the temperature sensor 402 and the user interface 408 (not shown in FIG. 7)—is mounted to the pump motor 502.

Suitable air temperature sensors for use in the controllers described above include, for example, negative temperature coefficient (NTC) thermistors, positive temperature coefficient (PTC) thermistors, and other devices capable of measuring air temperatures.

Although the memory devices shown in FIGS. 2-5 are illustrated as external to the processors, it should be understood that memory may instead (or also) be provided on-board the processors. The memory devices may be used to store various data including, for example, measured air temperatures, average air temperatures, normalized air temperatures, average normalized air temperatures, user-supplied run times, adjusted run time(s), temperature adjustment factors, run time multipliers, application-specific parameters, etc. Further, in some embodiments, the memory devices may be omitted.

Suitable processors for use in the controllers described above include, for example, microprocessors, microcontrollers, gate arrays, application specific integrated circuits (“ASICs”), etc.

Suitable user interfaces include, for example, switches, buttons, keypads, touch screens, joysticks, mouses, etc. Some embodiments may employ one or more user interfaces, while others may employ none.

The pump motor control signals described above can be any suitable signal including, e.g., a simple on/off signal, a signal indicating the amount of time the pump motor should run and/or the speed (or flow rate) at which the pump motor should run, etc.

Suitable motors for use in the assemblies described above include single speed motors and multi-speed motors (including motors having multiple discrete speeds such as two-speed motors as well as variable speed motors).

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A controller for a fluid pump, the controller comprising a processor for controlling a run time of the fluid pump, the processor configured to adjust the run time of the fluid pump based on a predetermined run time and a determined air temperature.

2. The controller of claim 1 further comprising a temperature sensor for measuring the air temperature, the processor operably coupled to the temperature sensor and configured to adjust the run time of the fluid pump based on the predetermined run time and the air temperature measured by the temperature sensor.

3. The controller of claim 1 wherein the processor is configured to average a plurality of air temperatures and adjust the run time of the fluid pump based on the predetermined run time and the average air temperature.

4. The controller of claim 1 wherein the processor is configured to normalize the determined air temperature based on when the determined air temperature was measured and adjust the run time of the fluid pump based on the predetermined run time and the normalized air temperature.

5. The controller of claim 4 wherein the processor is configured to average a plurality of normalized air temperatures and adjust the run time of the fluid pump based on the predetermined run time and the average normalized air temperature.

6. The controller of claim 1 further comprising a memory device operably coupled to the processor and storing a plurality of multipliers, each multiplier associated with a different air temperature, wherein the processor is configured to calculate the run time of the fluid pump as the product of the predetermined run time and the multiplier associated with the determined air temperature.

7. The controller of claim 1 wherein the run time of the fluid pump includes at least a first run time and a second run time, and wherein the processor is configured to adjust the first run time and the second run time based on the determined air temperature.

8. The controller of claim 7 wherein the processor is configured to control the fluid pump at a first speed or flow rate during the first run time and a second speed or flow rate during the second run time.

9. The controller of claim 1 further comprising a user interface through which a user can input the predetermined run time.

10. The controller of claim 1 further comprising an input for receiving an air temperature signal representing the determined air temperature, the processor configured to adjust the run time of the fluid pump based on the predetermined run time and the air temperature signal received at the input.

11. A pump assembly comprising a pump motor, a fluid pump operatively coupled to the pump motor for displacing fluid, and a controller for the pump motor, the controller configured to control a run time of the pump motor based on a measured air temperature.

12. The pump assembly of claim 11 wherein the controller includes a temperature sensor.

13. The pump assembly of claim 12 wherein the temperature sensor is thermally isolated from the pump motor.

14. The pump assembly of claim 11 wherein the controller includes a user interface through which a user can input a predetermined run time, and wherein the controller is configured to control the run time of the pump motor based on the predetermined run time and the measured air temperature.

15. A method of controlling a fluid pump, the method comprising determining an air temperature, determining a run time of the fluid pump based on the determined air temperature, and running the fluid pump for a duration corresponding to the determined run time.

16. The method of claim 15 wherein determining the air temperature includes determining a plurality of air temperatures over time and averaging the plurality of air temperatures to determine an average air temperature, and wherein determining the run time includes determining the run time of the fluid pump based on the average air temperature.

17. The method of claim 15 wherein determining the air temperature includes normalizing the air temperature based on when the air temperature was determined to determine a normalized air temperature, and wherein determining the run time includes determining the run time of the fluid pump based on the normalized air temperature.

18. The method of claim 15 wherein determining an air temperature includes determining a plurality of air temperatures over time, normalizing the plurality of air temperatures based on when the air temperatures were determined, and averaging the normalized air temperatures to determine an average normalized air temperature, and wherein determining the run time includes determining the run time of the fluid pump based on the average normalized air temperature.

19. The method of claim 15 wherein determining a run time includes determining at least a first run time and a second run time based on the determined air temperature, the first run time corresponding to a first pump speed or flow rate and the second run time corresponding to a second pump speed or flow rate, and wherein running the fluid pump includes running the fluid pump at the first pump speed or flow rate for a duration corresponding to the first run time and running the fluid pump at the second pump speed or flow rate for a duration corresponding to the second run time.

20. The method of claim 15 wherein determining the air temperature includes measuring the air temperature with a temperature sensor.

21. The method of claim 20 wherein determining the air temperature includes measuring the air temperature with the temperature sensor when the fluid pump has been off for a defined period of time.

22. The method of claim 15 wherein determining the run time includes determining the run time of the fluid pump based on the determined air temperature and a predetermined run time.

23. The method of claim 22 further comprising receiving the predetermined run time from a user.

24. The method of claim 15 wherein determining the run time includes multiplying a predetermined run time by a stored multiplier associated with the determined air temperature.
